(19) United States
(12) Patent Application Publication
(10) Pub. No.: US 2013/0291740 A1
(43) Pub. Date: Nov. 7, 2013

(54) CONNECTOR FOR A HARSH ENVIRONMENT

(71) Applicant: ACCUTEMP PRODUCTS, INC., Fort Wayne, IN (US)

(72) Inventor: Gary L. Seitz, Decatur, IN (US)

(73) Assignee: ACCUTEMP PRODUCTS, INC., Fort Wayne, IN (US)

(21) Appl. No.: 13/828,028

(22) Filed: Mar. 14, 2013

Related U.S. Application Data
(60) Provisional application No. 61/642,868, filed on May 4, 2012.

(51) Int. Cl. A47J 27/16; A47J 36/00; H01R 13/62

(52) U.S. Cl. CPC A47J 27/16; H01R 13/62; A47J 36/00
USPC 99/342; 439/367; 126/20

(57) ABSTRACT

A connector for receiving and transmitting signals from a sensor that is adapted for use in a harsh environment of, e.g., a steam cooker is disclosed. A connector of the present disclosure may be utilized in an environment having a high temperature relative humidity and which is under positive or negative pressure. A single conductor in the form of a male extension extends into a sealable cooking chamber and is sized to be received in a female connector communicatively connected to a sensor such as a temperature sensor. An arrangement of seals and inflators are interposed between the connector and the cooking chamber to isolate the connector and protect it from corrosion and electrical conductivity to the enclosure.

### CROSS-REFERENCE TO RELATED APPLICATION

This application claims priority under 35 U.S.C. 119(e) of U.S. Provisional Patent Application Ser. No. 61/642,868 filed on May 4, 2012 entitled Connector for a Harsh Environment, the entire disclosure of which is hereby incorporated by reference.

### BACKGROUND

1. Technical Field

The present disclosure relates to a connector for selectively communicatively connecting a sensor positioned in a harsh environment to a monitor and/or controller. More particularly, the present disclosure relates to a connector for selectively communicatively connecting a sensor positioned in a cooking device to a monitor such as a controller.

2. Description of the Related Art

Many cooking devices provide an optional temperature sensor which can be inserted into or otherwise associated with a product being cooked to communicate the temperature of such product outside of the cooking device. For example, a temperature probe may be inserted into a piece of meat contained within the heated space of a cooking device, with the probe further selectively connected to a port in the cooking device to provide a signal indicative of the temperature of the product being cooked to a monitor. For the purposes of this document, “monitor” is meant to denote any device or arrangement for observing, recording, displaying or comparing information with a recorded value. A monitor may take the form of a controller including a comparator. A monitor may further take the form of a display and/or an alarm configured to report temperature at or above a desired level.

Steam cookers are widely used in commercial food service applications because they can rapidly reheat or cook large quantities of food while maintaining food quality. To heat and/or cook food in a steam cooker, water is heated into a change of phase to become steam. The steam is then circulated through the cooker using a fan or other circulation mechanism to allow the steam to contact the food and increase the temperature of the food.

Available temperature sensors include temperature probes having a spike for insertion into a food product and an opposite end having a male connector. Cooking devices utilizing these types of probes provide a female connector at the interior of the cooking space that is further connected to a monitor of some type. Such connection types are not adaptable to the harsh environment of a steam cooker, where pressure or vacuum, temperature and relative humidity are very high. In the environment of a steam cooker, condensation can form on the interior of the female connector and cause corrosion.

### SUMMARY

The present disclosure relates to a connector for receiving and transmitting signals from a sensor that is adapted for use in a harsh environment of, e.g., a steam cooker. For example, the connector of the present disclosure may be utilized in a “harsh environment” having a temperature of about 100° F. to 212° F. (or atmospheric boiling point) and a relative humidity of 100%. The connector of the present disclosure includes a signal conductor in the form of a male extension that extends into a sealable cooking chamber. The male connector extension is sized to be received in a female connector communicatively connected to a sensor such as a temperature sensor. An arrangement of seals and insulators are interposed between the connector of the present disclosure and the cooking chamber to isolate the connector and protect it from corrosion and unintended electrical conduction.

The disclosure, in one form thereof, provides a connector for receiving and transmitting a signal from a sensor positioned in a harsh environment to a monitor position remote from the harsh environment. The connector of this form of the present disclosure includes an electric signal conductor comprising a male connector extension sized to be received in the female connector communicatively connected to the sensor, a first electric insulator, a first seal supported by the first electric insulator for hermetically sealing the first electric insulator relative to the electric signal conductor, a second seal supported by the first electric insulator for hermetically sealing the first electric insulator relative to a support structure, a fastener securable to the signal conductor to sandwich the support structure between the electric signal conductor and the fastener, and a second electric insulator interposed between the fastener and the first electric insulator when the fastener is secured to the signal conductor. The support structure may be interposed between the first electric insulator and the second electric insulator so that the support structure is electrically isolated from the electric signal conductor and the support structure is hermetically sealed relative to the electric signal conductor. The disclosure, in another form thereof, provides a cooking device including a sealable cooking chamber, a heat source, and a connector for receiving and transmitting a signal from a sensor within the sealable cooking chamber to a monitor outside the sealable cooking chamber. In this form of the present disclosure, the connector includes a male signal conductor extending through a wall defining the sealable cooking chamber and into the sealable cooking chamber. The male signal conductor is sized to engage a female connector communicatively connected to the sensor.

In alternative forms of the present disclosure, the heat source may comprise a source of steam such that the cooking device comprises a steam cooker.

A temperature probe such as a probe incorporating a resistance temperature detector, a thermistor or a thermocouple.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a commercial food service steamer incorporating a number of signal connectors of the present disclosure;

FIG. 2 is a partial perspective, exploded view illustrating a signal connector of the present disclosure and a temperature probe;

FIG. 3 is a partial sectional view of the signal connector of the present disclosure operably connected to the steamer of FIG. 1; and

FIG. 4 is a sectional view of the female connector extending from the temperature probe illustrated in FIG. 2.

Corresponding reference characters indicate corresponding parts throughout the several views. Although the exemplification set out herein illustrates an embodiment of the invention, the embodiment disclosed below is not intended to be exhaustive or to be construed as limiting the scope of the invention to the precise form disclosed.

### DETAILED DESCRIPTION OF THE PRESENT INVENTION

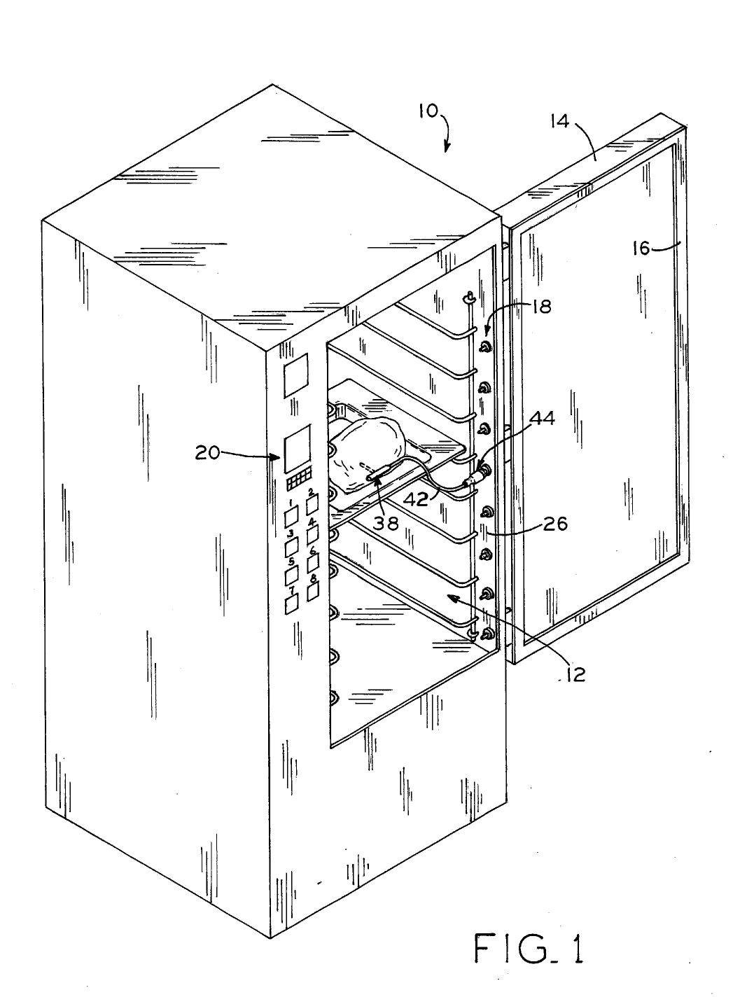

FIG. 1 illustrates steamer 10 including sealable cooking chamber 12 including a plurality of pan racks. Sealable cooking chamber 12 is connected to a source of steam to provide for cooking of food items placed therein. The source of steam may be local, i.e., an integral steam generator and/or a reservoir of heated water, or sealable cooking chamber 12 may be fluidly connected to a remote steam generator. Door 14 is pivotally connected to steamer 10 and includes seal 16 which cooperates with a door face of steamer 10 to hermetically seal sealable cooking chamber 12 during cooking of food items. The present invention may be utilized, e.g., with the steamers such as the Steam ‘N’ Hold™ and Evolution Steamers available from AccuTemp Products, Inc. of Fort Wayne, Ind. Such steamers are designed to create a cooking chamber having a temperature in the range of 100° F. to 212° F. (or atmospheric boiling point) and a relative humidity approaching 100%. Further, the cooking chambers of such steamers may be placed at positive or negative pressure. As such, cooking chamber 12 comprises a harsh environment.

FIG. 1 illustrates a plurality of signal conductors 18 extending inwardly into sealable cooking chamber 12. Each signal conductor 18 is positioned near the door face of steamer 10 and spaced between the individual pan support racks so as to be out of the way of pans being positioned in steam cooker 10. Each signal conductor 18 is communicatively connected to monitor 20. Signal conductors 18 in accordance with the present disclosure may be connected to a monitor in many forms. For example, signal conductors 18 may be connected to a monitor in the form of a controller including a comparator. Further, signal conductors 18 may be connected to a display and/or an alarm device configured to report a particular signal received by signal conductors 18. For example, a signal conductor 18 may be communicatively connected to a monitor in the form of a controller having a comparator and a stored value, such as the desired temperature for a particular food product (e.g., roast beef). In such circumstance, the monitor may signal when such desired temperature has been communicated to the controller via a signal conductor 18. Further, reaching such temperature may cause an audible alarm.

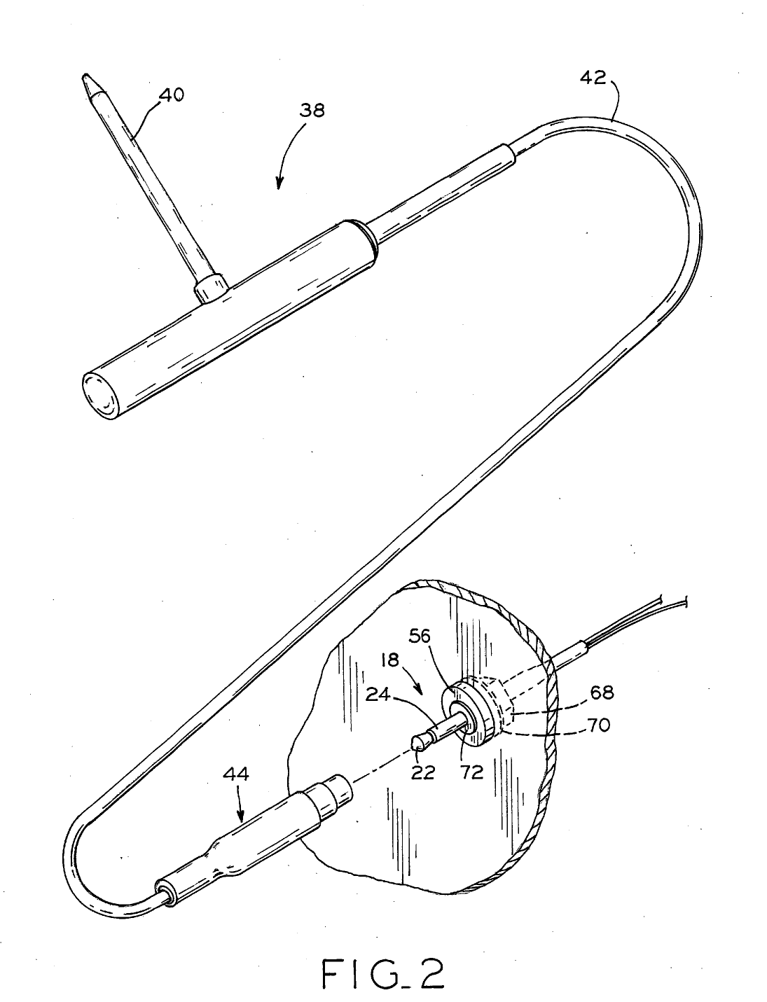

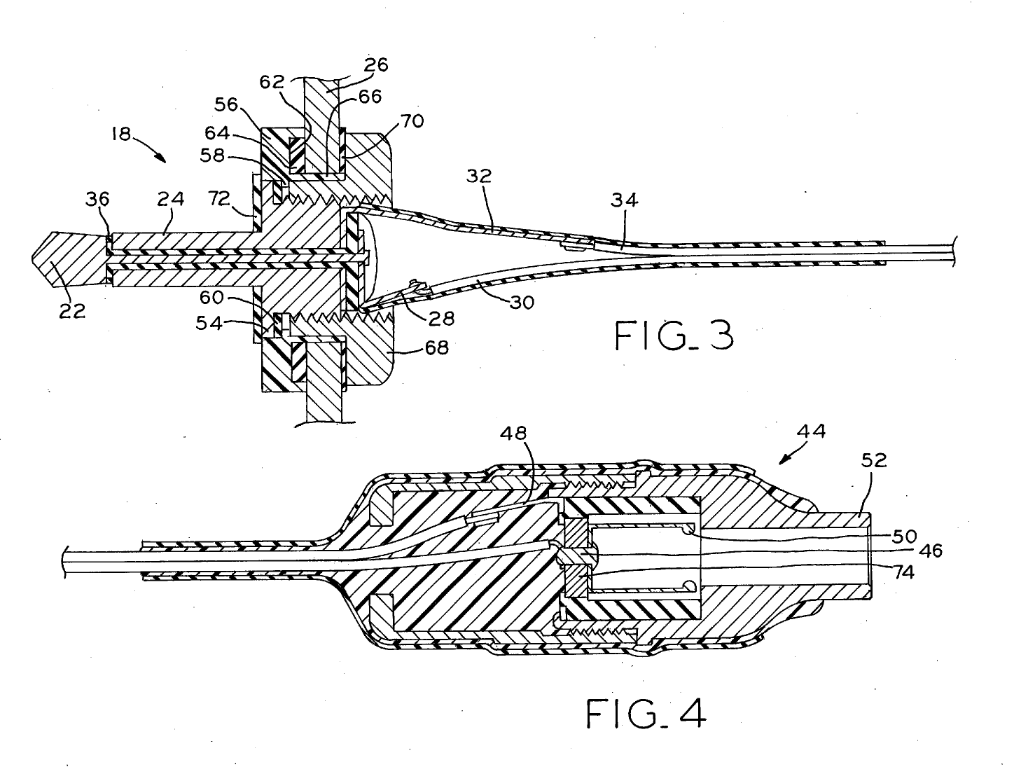

One of signal conductors 18 illustrated in FIG. 1 is illustrated in detail in FIGS. 2 and 3. Signal conductor 18 comprises a coaxial conductor arrangement including first conductor 22 (in the form of a post) positioned within and surrounded by second conductor 24. As illustrated in FIGS. 2 and 3, first signal conductor 22 is positioned within and through a bore found through second signal conductor 24, with first signal conductor 22 extending beyond the limit, i.e., beyond the axial terminal end, of second signal conductor 24. Stated another way, first signal conductor 22 extends further from cooking chamber wall 26 than does second signal conductor 24.

First signal conductor 22 is communicatively connected to contact 28. In the exemplary embodiment illustrated, first and second signal conductors 22, 24 are both electrical conductors which are operable to communicate an analog signal. In alternative forms of the present disclosure, the signal conductors may be digital signal conductors such as, e.g., optical cable connectors.

Contact 28 is an electrical conductor which is secured to first conductor 22 and thereafter to wire 30. Similarly, second conductor 24 is connected to contact 32 which is subsequently connected to wire 34. As illustrated in FIG. 3, first conductor 22 is electrically isolated from second conductor 24 by phenolic material 36 which precludes any contact between first conductor 22 and second conductor 24. Throughout this document, “electrically isolate” is meant to signal the lack of appreciable electric conduction between the “electrically isolated” items. Phenolic material 36 further electrically isolates contact 28 from contact 32 by precluding contact therebetween. With the conducting arrangement of signal conductor 18 illustrated in FIG. 3, a signal from temperature probe 38 may be received and transmitted by signal conductor 18 to monitor 20 (that is, wires 34, 30 are communicatively connected to monitor 20).

Temperature probe 38 includes spike 40 for penetrating a food item as illustrated in FIG. 1. In typical constructions, temperature probe 38 will include a temperature sensor positioned in spike 40, e.g., at the distal end of spike 40, such that a change of temperature in the vicinity of spike 40 is thermally transmitted to the temperature sensor. For example, spike 40 may house a resistance temperature detector (RTD), a thermistor or a thermocouple, with the chosen temperature sensor encased in, e.g., a stainless steel to form spike 40. The temperature sensor is communicatively connected via wires contained in casing 42 to female connector 44, which is illustrated in detail in FIG. 4.

Referring to FIG. 4, female connector 44 of temperature probe 38 includes electrical contacts 46, 48 which are electrically connected to the temperature sensor housed in spike 40. As illustrated in FIG. 4, contact 46 is electrically isolated from contact 48 by phenolic material 74. Phenolic material 74 further electrically isolates contact 50, which is electrically coupled to contact 48, from contact 46 by being interposed therebetween (not shown in FIG. 4). Signal conductor 18 may be communicatively connected to temperature probe 38 by inserting signal conductor 18 into entry tube 52 of female connector 44. Upon insertion, first conductor 22 becomes electrically connected to contact 46 of female connector 44 by coming into axially abutting contact therewith, while second conductor 24 becomes electrically connected to contact 50 (which is electrically connected to contact 48) of female connector 44 by coming into radially abutting contact therewith. Contacts 46, 48 are electrically isolated from one another by phenolic material 74, as noted above, and able to independently communicate with first and second conductors 22, 24 of signal conductor 18.

Advantageously, signal conductor 18 does not present an opening, or a concavity into which condensation from sealable cooking chamber 12 can penetrate or accumulate. Further, signal conductor 18 is sealed relative to cooking chamber wall 26 so that moisture from within sealable cooking chamber 12 cannot pass through cooking chamber wall 26 in the vicinity of signal conductor 18. Referring to FIG. 3, second conductor 24 includes annular conductor flange 54. Signal conductor 18 further includes first electric insulator 56 in the form of an annular ring and including annular insulator flange 58. Seal 60 is sandwiched between insulator flange 58 and conductor flange 54 to effect sealing between second conductor 24 and first electric insulator 56.

In an exemplary embodiment, first electric insulator 56 is formed of Ryton® available from Chevron Phillips Chemical Company. Ryton® is a polyphenylene sulfide and may be used to form any of the electric insulators described in this document. In specific embodiments, a polyphenylene sulfide mixed with fiberglass may be used to form any of the electric insulators described in this document. In an exemplary embodiment, seal 60 comprises a silicone O-ring. Any of the seals of the present application may be formed of compounds such as vinyl methyl silicone rubber or fluorovinyl methyl silicone rubber, or an ethyl cyanoacrylate (as described below) and are effective to form hermetic seals.

As illustrated in FIG. 3, first electric insulator 56 further includes annular channel 62 housing seal 64. First electric insulator 56 includes cylindrical extension 66 extending through a correspondingly sized and shaped aperture in cooking chamber wall 26. Nut 68 includes internal threading which is compatible with external threading formed about a boss of second conductor 24, as illustrated in FIG. 3, such that threading of nut 68 to second conductor 24 will sandwich cooking chamber wall 26 therebetween. As illustrated in FIG. 3, second electric insulator 70, formed as a disc or washer having a central aperture, is interposed between nut 68 and cooking chamber wall 26.

In construction, signal conductor 18 is fitted with O-ring seal 60 received upon and positioned about the threaded extension of second conductor 24. First electric insulator 56 is thereafter positioned about the threaded end of second conductor 24 and O-ring seal 64 is positioned within annular channel 62 of first electric insulator 56. Cylindrical extension 66 of first electric insulator 56 may then be passed through an appropriately sized aperture formed in cooking chamber wall 26 to achieve the position illustrated in FIG. 3. Thereafter, second electric insulator 70 is positioned about the cylindrical threaded extension extending from the head of nut 68, as well as the axial terminal end of cylindrical extension 66 as shown. The threaded extension of nut 68 is threadedly engaged with the threaded extension of second conductor 24. In this position, nut 68 is rotated to draw the flanged head of nut 68 toward conductor flange 54 of second conductor 24 and first electric insulator 56. As such movement is effected, seals 60, 64 are compressed and signal conductor 18 is tightly held relative to cooking chamber wall 26, with cooking chamber wall 26 tightly sandwiched between second conductor 24 and nut 68, as illustrated in FIG. 3.

With the construct illustrated in FIG. 3, first electric insulator 56 and second electric insulator 70 function to electrically isolate signal conductor 18 relative to cooking chamber wall 26. This is important because cooking chamber wall 26 is typically formed of a metal, e.g., stainless steel, which is a good electrical conductor. Conductors 22, 24 will also be formed of a good electrical conductor such as, a nickel plated copper. Generally, all of the “electrical conductors” described in this document will be formed of copper, nickel plated copper, gold plated copper, brass, nickel plated brass, gold plated brass or aluminum and have an electrical conductivity defining a resistance of ideally about 0 ohm (Ω). In embodiments of the present disclosure, the “conductors” will have a resistance of less than 100 Ω. Similarly, “electric insulators” in the present disclosure will be formed of materials such as the ones mentioned above and will have an electrical conductivity defining a resistance of at least about 1 mega-ohm (MΩ) or more. Similarly, nut 68 is a metallic nut that will be placed in electrically conductive relationship with second conductor 24 and electrically insulated from cooking chamber wall 26 by second electric insulator 70, as illustrated in FIG. 3. With seals 60, 64 and electric insulators 56, 70 positioned as illustrated in FIG. 3, signal conductor 18 is electrically insulated from sealable cooking chamber 12 and the aperture in cooking chamber wall 26 through which signal conductor 18 is positioned is hermetically sealed from cooking chamber 12. To further effect hermetic sealing of signal conductor 18 from cooking chamber 12, phenolic material 36 may be treated with loctite® 380 available from the Henkel Corporation of Dusseldorf, Germany. Loctite® 380 is an ethyl cyanoacrylate that can be utilized to effect a hermetic seal. Because phenolic material 36 is porous, loctite® 380 may be applied at the exposed areas of phenolic material 36 and such compound will be drawn or wicked into the phenolic material to effect a non-porous hermetic seal between first conductor 22 and second conductor 24. In similar fashion, loctite® 380 may be applied to phenolic material 74 of female connector 44.

Referring to FIGS. 2 and 3, disc seal 72 includes an aperture through which first conductor 22 and second conductor 24 can be positioned, with seal 72 fitting snugly about the circumference of second conductor 24. When female connector 44 is operably positioned over signal conductor 18, the circular terminal end of the entry tube 52 will abut seal 72 about the circumference thereof to hermetically seal entry tube 52.

While this disclosure has been described as having an exemplary design, the present disclosure can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A connector for receiving and transmitting a signal from a sensor positioned in a harsh environment to a monitor positioned remote from the harsh environment, the connector comprising:
an electric signal conductor comprising a male connector extension sized to be received in a female connector communicatively connected to the sensor;
a first electric insulator;
a first seal supported by said first electric insulator for hermetically sealing said first electric insulator relative to said electric signal conductor;
a second seal supported by said first electric insulator for hermetically sealing said first electric insulator relative to a support structure;
a fastener securable to said signal conductor to sandwich the support structure between the electric signal conductor and said fastener; and
a second electric insulator interposed between said fastener and said first electric insulator when said fastener is secured to said signal conductor, whereby the support structure may be interposed between the first electric insulator and the second electric insulator so that the support structure is electrically isolated from the electric signal conductor and the support structure is hermetically sealed relative to the electric signal conductor.

2. The connector of claim 1, wherein said fastener comprises a threaded nut and wherein said electric signal conductor comprises a threaded extension and a conductor flange, said first seal positioned about said threaded extension, said first electric insulator positioned about said threaded extension, said first seal sealing said conductor flange relative to said first electric insulator.

3. The connector of claim 1, wherein said first electric insulator comprises an annular channel, said second seal occupying said annular channel.

4. The connector of claim 1, wherein said signal conductor comprises a coaxial conductor comprising a first conductor positioned within a second conductor, said first conductor extending beyond an axial terminal end of the second conductor, said connector further comprising a seal between said first conductor and said second conductor to hermetically seal said first conductor relative to said second conductor.

5. A cooking device, comprising:
a sealable cooking chamber;
a heat source; and
a connector for receiving and transmitting a signal from a sensor within said sealable cooking chamber to a monitor outside said sealable cooking chamber, said connector comprising:
a male signal conductor extending through a wall defining said sealable cooking chamber and into said sealable cooking chamber, said male signal conductor sized to engage a female connector communicatively connected to the sensor.

6. The cooking device of claim 5, wherein said connector further comprises at least one seal hermetically sealing said signal conductor relative to said wall defining said sealable cooking chamber.

7. The cooking device of claim 5, wherein said signal conductor comprises an electrical signal conductor, and wherein said connector further comprises:
a first electric insulator interposed between said connector and said wall defining said sealable cooking chamber and electrically isolating said conductor from the wall defining said cooking chamber.

8. The cooking device of claim 7, wherein said connector further comprises;
a first seal sealingly engaging said signal conductor and said first electric insulator; and
a second seal sealingly engaging said first electric insulator and said wall defining said sealable cooking chamber.

9. The cooking device of claim 8, wherein said connector further comprises a fastener secured to said signal conductor to sandwich said wall between said signal conductor and said fastener, said connector further comprising:
a second electric insulator interposed between said fastener and said wall and electrically isolating said conductor from the wall defining said cooking chamber.

10. The cooking device of claim 9, wherein said first electric insulator comprises an insulator flange, said first seal sealing said insulator flange relative to said signal conductor, said first electric insulator further comprising an annular channel, said second seal occupying said annular channel, said signal conductor comprising a conductor flange, said first seal interposed between said conductor flange and said insulator flange.

11. The cooking device of claim 10, wherein said fastener comprises a threaded nut and wherein said signal conductor comprises a threaded extension, said first seal positioned about said threaded extension, said first electric insulator positioned about said threaded extension, whereby threading of said nut to said threaded extension compresses said first seal and said second seal.

12. The cooking device of claim 11, wherein said signal conductor comprises a coaxial conductor comprising a first conductor positioned within a second conductor, said first conductor extending beyond a terminal axial end of the second conductor, said second conductor forming said conductor flange, said connector further comprising a conductor seal between said first conductor and said second conductor.

13. The cooking device of claim 12, wherein said signal conductor further comprises a third seal positioned about said second conductor, the cooking device further comprising a temperature probe, said temperature probe comprising the sensor, the temperature probe including the female connector sized to engage said signal conductor, whereby, with said female connector engaging said signal conductor, said third seal engages said female connector to hermetically seal an interior of said female connector.

14. The cooking device of claim 5, wherein said heat source comprises a source of steam and wherein said cooking device comprises a steam cooker.

15. The cooking device of claim 5, wherein said cooking device further comprises:
a temperature sensor, said temperature sensor comprising the sensor.

16. The cooking device of claim 15, wherein said temperature sensor comprises a penetration temperature probe for penetrating an item of food to a penetration point to determine the temperature of the item of food at the penetration point.

17. The cooking device of claim 16, wherein said temperature probe comprises one of a resistance temperature detector, a thermistor and a thermocouple.
